(19) United States
(12) Patent Application Publication
(10) Pub. No.: US 2011/0270423 A1
(43) Pub. Date: Nov. 3, 2011

(54) Method for transferring parameter data in the case of uploading and/or downloading parameter settings between field devices and/or a control station

(75) Inventor: Stefan Maier, Rheinfelden (DE)

(73) Assignee: Endress + Hauser GmbH + Co. KG, Maulburg (DE)

(21) Appl. No.: 13/142,640

(22) PCT Filed: Dec. 14, 2009
(86) PCT No.: PCT/EP09/67035

§ 371 Date: Jun. 29, 2011

(30) Foreign Application Priority Data
Dec. 30, 2008 (DE) 10 2008 055 192.9

(51) Int. Cl. G05B 19/042

(52) U.S. Cl. 700/87

(57) ABSTRACT

A method for reducing parameter data to be transferred in the case of uploading and/or downloading parameter settings between field devices and/or a control station, wherein the parameter data include information concerning an operating state of the field device and/or information concerning a process variable registered with the field device and/or identification data of the field device. Data present after a re-setting procedure or during the start-up of the field device are established as standard parameter data, wherein, for each parameter, modification information is stored concerning whether such parameter deviates from the standard parameter data, only such parameter data are transmitted, in the case of which a deviation from the standard parameter data is ascertained via the modification information.

The invention relates to a method for transferring parameter data in the case of uploading and/or downloading parameter settings between field devices and/or a control station as such method is defined in the preamble of claim 1.

Today, in automation technology, field devices are applied, which serve for registering and/or influencing process variables. Examples of such field devices for registering process variables are fill level measuring devices, mass flow meters, pressure meters, temperature measurers, etc., which register the corresponding process variables, fill level, mass flow, pressure, or temperature. Examples of field devices for influencing process variables are so-called actuators, which, for example serving as valves, control the flow a liquid in a pipeline section, or, serving as pumps, control the fill level of a medium in a container.

The field devices are connected via corresponding communication connections—as a rule, via a data bus—with a process control center, which controls the entire process flow, or enables a direct accessing of the individual field devices for servicing, parametering or configuring. Through the direct accessing, settings (e.g. parameters) can be changed in the field device or special diagnostic functions can be invoked. Besides accessing via the process control center, a temporary accessing, e.g. via a portable handheld servicing device, portable computer or a cell phone, is also possible.

In order to enable the servicing of various field devices from the process control center, the functionality of the field device must be known to the process control center. The functionality of a field device is normally described by means of a device description. For this, special standardized device description languages are available; examples are CAN-EDS (Control Area Network-Electronic Data Sheet), HART-DDL (HART-Device Description Language), FF-DDL (Fieldbus Foundation-Device Description Language), Profibus-GSD (Profibus-General Station Description), Profibus-EDD (Profibus Electronic Device Description). From the process control center, the servicing of the field device most often occurs via a graphical user interface, which facilitates start-up, maintenance, data backup, problem resolution and device documentation.

In the process control center, the measured values of the different process variables are evaluated or monitored and the corresponding actuators are operated.

The data transmission between the field device and the process control center occurs in a hardwired or wireless manner according to one of the known international standard for fieldbusses, e.g. HART, Foundation Fieldbus, Profibus, CAN, etc., or, for remotely positioned plant parts, over public communication networks.

In the case of a process controlled by the process control center, wherein the process is distributed over a number of sites and/or includes a plurality of field devices, the amount of data to be transferred can lead to an overloading of the data bus systems, or the public networks can be used for too long.

An object of the invention is therefore to provide a method for a more efficient transmission of parameter data in a distributed process automation system.

This object is achieved as regards the method of the invention by the features of claim 1. Advantageous embodiments and further developments of the invention are set forth in the dependent claims.

A main idea of the invention is that the current parameter data are compared with stored standard parameter data and, in the case of differences, the associated modification information I is set to “true”. In the case of transmission from the field device to the control station or vice versa, only such parameter data are transmitted, in the case of which a deviation from the standard parameter data is displayed by the modification information I. The process data include information concerning the operating states of the field devices and/or information concerning the process variables registered with the field devices and/or identification data of the respective field device. The terminology “field device” means, in such case, also actuators for influencing the process variables.

A more efficient transmission of the parameter data is achieved in the case of a further development of the invention, wherein, before downloading parameter data from the control station to the field device, via a re-setting procedure of the field device, the standard parameter data are loaded in the field device.

An additional reducing of the process data to be transferred is advantageously achieved by the features that status information of the parameter data transmitted in preceding transmissions is monitored and, in the case of a renewed change in this monitored status information, a transmission of the changed parameter data is started automatically.

In the case of an especially advantageous form of embodiment of the invention, specifications for the evaluation of the process data and/or for performing the transmission of the reduced process data are influenceable by a user.

In the case of an advantageous embodiment of the invention, the predetermined conditions for triggering a data transmission, as specifications, include, for example, a certain time span and/or a predetermined clock time. Additionally, the specifications can also include the occurrence of certain events, such as, for example, the reaching and/or exceeding of predetermined threshold values or alarm criteria. In this way, the number of data transmissions and thus the amount of data is reduced.

By reducing the amount of data to be transferred, i.e. by more efficient transmission, especially the costs for the use of telephone networks (public switched telephone network or radio networks) are reduced.

In an advantageous further development of the method, all specifications which are possible for a field device and which are influenceable by the user are stored in an individual device description file belonging to the field device. The device description file additionally describes the functionality of the associated field device and also includes, for example, data concerning the process variables which can be ascertained and/or influenced with the field device, and which, as static data, are otherwise transmitted from the field device to the process control center. By means of the identification data, the field device's individual device description file is associated with the field device.

Data transmission between the field device and the process control station occurs via a local data bus and/or a long distance connection.

In an especially advantageous form of embodiment of the invention, the Internet is used as a communication platform between the field device and the process control station.

In an additional form of embodiment of the invention, data transmission between the field device and the process control station is unidirectional, wherein, when data must be transmitted from the process control station to the field device, a bidirectional communication is performed.

This measure is especially important for sites, for example in remote, large warehouses, where the field device is, for energy saving purposes, normally turned off, and is only activated in the case of the presence of predetermined conditions, for example, in the case of the elapsing of a certain time span, or at certain clock times. After activation, the field device ascertains the process data, which are then evaluated, stored and transmitted to the process control center. The field device remains activated for a predetermined time span, and switches itself back off upon the elapsing of the time span. During this time span, after obtaining the process data, the process control center checks whether new data—for example, changed conditions for triggering a data transmission—must be transmitted to the field device. If no such new data are transmitted from the process control center to the field device, the field device switches itself back off after the predetermined time span.

For performing the method of the invention, a control/evaluation unit is provided, wherein the control/evaluation unit reads out the modification information I of the parameter data, and stores their status in a memory unit, wherein the memory unit can be part of the control/evaluation unit, and wherein the control/evaluation unit forms the parameter data to be transferred on the basis of the changes in the modification information I, and, by means of corresponding communication systems, transmits these data to the process control center. For the input of predeterminable conditions by the operator, in the case of an advantageous form of embodiment, corresponding service and display units are provided, which, for example, are arranged in the process control center.

Furthermore, the control/evaluation unit can also be an integral component of the field device.

Other details, features and advantages of the subject matter the invention will become evident from the following description and the associated drawing, in which preferred examples of embodiments of the invention are presented. For better overview and simplification in the examples of embodiments of the invention presented in the figures, elements of equal construction and/or function are provided with equal reference characters. The figures of the drawing show as follows:

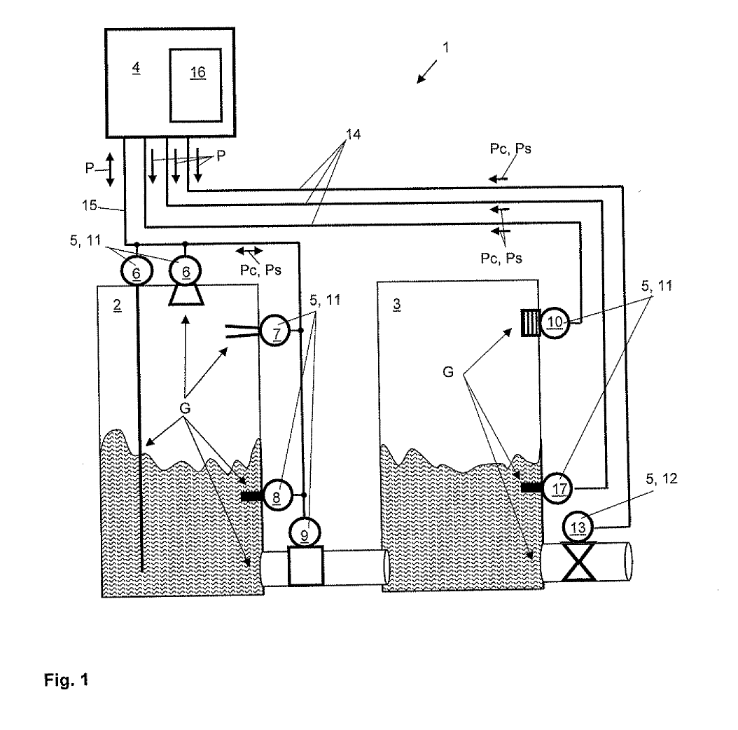

FIG. 1 a schematic representation of a distributed process automation plant; and

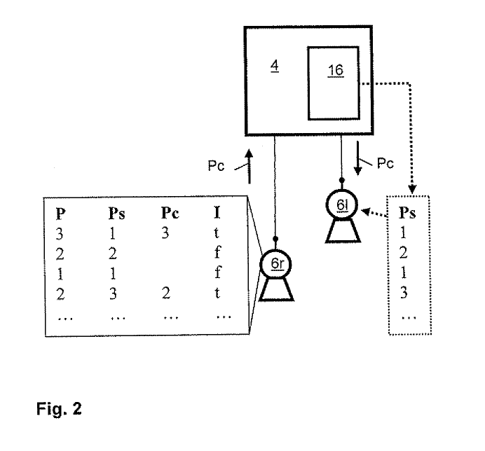

FIG. 2 another schematic representation of a distributed process automation plant.

FIG. 1 shows a process automation system 1 of the invention. Process automation system 1 is constructed of a control station 4 and a plurality of field devices 5 in or on a container of a first process 2 and in or on a container of a second process 3. The individual field devices 5 communicate among one another and with the control station 4 via a fieldbus 15 and/or a two-wire connecting line 14. Integrated in control station 4 is a control and evaluation unit 16, which controls the automation process, evaluates the measured values or actuating values of the individual field devices 5 and/or the analyzes and diagnoses the information I and the measured values Mx of the field devices 5. A process variable G or procedure variable is a physical variable, which occurs exclusively during state changes and, as a result, is path dependent. The measured values and actuating values are values of process variables G or state variables of the process 2, 3 and are ascertained by the sensor 11 or actuator 12 of the field devices 5.

Installed in the first process 2 are, for example, in FIG. 1, two fill level measuring devices 6, a limit-level measuring device 7 and an analytical measuring device 8. Integrated between the containers of the first process 2 and the second process 3 is a flow measuring device 9, which ascertains transport of fill substance between the two containers of processes 2, 3. The field devices 5 of the first process 2 communicate with one another and/or with the control station 4 via a digital fieldbus 15, e.g. a Profibus PA or Fieldbus fieldbus. Analogously to the wired communication via digital fieldbus 15, the communication can also be embodied to occur via a corresponding wireless communication unit according to one of the known standards, e.g. ZigBee, WLAN, Bluetooth. This is, however, not explicitly detailed in the example of an embodiment shown in FIG. 1.

Field devices 5 integrated in the second process 3 include, for example, a pressure measuring device 10, a temperature measuring device 17 and an actuator 13 for operating a valve. All of these field devices 5 communicate with control station 4 or among one another via a direct, two-wire, connecting line 14. The communication via two-wire connecting line 14 occurs, for example, according to the HART-standard, which modulates a digital, high-frequency signal as additional information carrier onto an analog 4-20 mA electrical current signal.

As is evident from FIG. 1, the illustrated process automation system 1 is distributed over two sites with a first container 2 and a second container 3. Occurring at the individual sites are process portions, which are part of a multisite-encompassing process, for example, a warehouse monitoring or warehouse optimizing process, or a production monitoring or production optimizing process. The process portions can be service and/or display processes and/or control (open or closed loop) and/or regulating processes and/or communication processes and/or storage processes and/or processes for measuring and/or ascertaining process variables and/or processes for influencing process variables.

FIG. 1 shows a control station 4 having at least one microprocessor, and a fieldbus 15 for data transmission and/or parameter transmission.

In the illustrated example of an embodiment, all control/evaluation units 16 are indeed embodied as independent devices; however, it is fundamentally possible that control/evaluation unit 16 is part of a field device 5. This is true also for the illustrated fieldbus 15 for data exchange with control station 4.

There frequently exists the need to back up or to save the parameter settings of a field device 5 in a control station 4, e.g. a computer, laptop or PDA. On the one hand, in the case of a device replacement, e.g. due to of a defect, one would like to load the parameters P into the new field device 5 again in simple manner. On the other hand, one would, in the case of the same applications, like to copy the parameter data set into other field devices 5. As a rule, this uploading and downloading consumes a great deal of time. The cause lies in the fact that the values of all parameters of field device 5 are loaded to the control station 4 or vice versa. This method does not take into consideration whether or not the current parameters P were changed by operator of the process automation plant 1.

An already applied opportunity to shorten the transmission time is to transfer only a subset of the parameter data P, to be established during development of the DD or the DTM. Only the “most important” parameters are to be taken into consideration in the case of uploading and downloading. A change in parameter data P of “non-important” parameters P is, in such case, not taken into consideration, and is not loaded to or from control station 4 or the PC, and is thus lost.

The idea is to connect the uploading and downloading with the fact that the parameter state is defined after a re-setting of the field device 5.

To each parameter P there is joined in the field device 1 a modification information I as a status value. This status value is used to identify a parameter datum P deviating from the standard parameter data Ps. If the operator of the process automation plant changes a parameter P, the modification information I is set, for example, to “true”. In the case of uploading the parameter data P into the control station 4, only the parameter data Pc are transmitted. Thus, only parameter data which are changed from the standard parameter data Ps are loaded from field devices 5 into control station 4.

The transmission time of parameter data P into control station 4 thus depends on the number of changed parameter data Pc. In the best case, no parameter data P need be transmitted; however, in the worst case, all parameter data P is transmitted. By this embodiment of the need-oriented transmission of the invention, no changes in the parameter data are lost. In the case of the downloading of the data to field device 4, a re-set-procedure for parameters P is first performed in field device 4. It is thereby assured that the parameters P, which are not contained in the downloaded parameter data set P, are set to their correct initial value.

The state of the parameters P after a re-set procedure is fixed by the programming of the device software for the lifetime of the relevant software version, and can thus also be implemented in the device driver of field devices 5 and/or control station 4. Thus, also after an offline parametering, only those parameters P which were changed offline need be stored.

FIG. 2 shows a control station 4 communicating with two field devices 5 via a two-wire line 14. In order to copy the parameter data P of the right fill-level measuring device 6r to the left fill-level measuring device 6l, the changed parameter data Pc are read into the control/evaluation unit 16 of control station 4. These changed parameter data Pc are produced in the right fill-level measuring device 6r by registering the modification information I for the current parameter data P. Only those data sets are transmitted, whose modification information I contains the status “true”. Modification information I contains the status “true” for all changed parameters Pc, whose parameter data and standard parameter data Ps do not agree. Thus, only the changed parameter data Pc of the right fill-level measuring device 6r are transmitted to control station 4. Control/evaluation unit 16 in control station 4, before it dispatches the changed parameter data Pc to the left fill-level measuring device 6l, produces in this left fill-level measuring device 6l a re-set procedure, so that the current parameters P are overwritten by the stored, standard parameter data Ps. After left fill-level measuring device 6l has been re-set back to the standard parameter data Ps, the changed parameter data can be transmitted from control/evaluation unit 16 in control station 4 to the left fill-level measuring device 6l.

### LIST OF REFERENCE CHARACTERS

1 process automation system
2 first process/first container
3 second process/second container
4 control station
5 field device
6 fill-level measuring device
7 limit-level measuring device
8 analytical measuring device
9 flow measuring device
10 pressure measuring device
11 sensor
12 actuator
13 actuator
14 two-wire connecting line
15 digital fieldbus, fieldbus
16 control/evaluation unit
17 temperature measuring device
P parameter, parameter data
Pc changed parameter, changed parameter data
Ps standard parameter data
I modification information
G process variable
Z state variable

1-8. (canceled)

9. A method for transferring parameter data in the case of uploading and/or downloading parameter settings between field devices and/or a control station, wherein the parameter data include information concerning an operating state of the field device and/or information concerning a process variable registered with the field device and/or identification data of the field device, comprising the steps of:
establishing parameter data present after a re-setting procedure or during start-up of the field device as standard parameter data;
storing for each parameter, modification information concerning such parameter deviates from the standard parameter data; and
transmitting only such parameter data, in the case of which a deviation of the standard parameter data is ascertained via the modification information.

10. The method as claimed in claim 9, wherein:
in the case of change of a parameter, its modification information is set to “true”.

11. The method as claimed in claim 9, wherein:
before downloading parameter data from the control station to the field device, the standard parameter data are loaded into the field device via a re-setting procedure of the field device.

12. The method as claimed in claim 9, wherein:
before an uploading of parameter data from the field device to the control station, the modification information of the individual parameter data are ascertained, and only changed parameter data are transmitted.

13. The method as claimed in claim 9, wherein:
the standard parameter data are stored in a device driver.

14. The method as claimed in claim 13, further comprising the step of:
monitoring modification information of parameter data transmitted in preceding transmissions; and
in the case of a new change in monitored modification information, a transmission of the changed parameter data is started automatically.

15. The method as claimed in claim 9, wherein:
before ascertaining and/or transmitting changed parameter data, standard parameter data in the control station and the field devices are compared.

16. The method as claimed in claim 15, wherein:
a comparison of standard parameter data is performed via a comparison of version identification numbers.
